(19) United States
(12) Patent Application Publication
(10) Pub. No.: US 2003/0076552 A1
(43) Pub. Date: Apr. 24, 2003

(54) Contact image sensor (CIS)

(75) Inventors: Kevin Lo, Taipei (TW); Yu Lung Fang, Taipei (TW)

Correspondence Address: VOLPE AND KOENIG, P.C., SUITE 400, ONE PENN CENTER, 1617 JOHN F. KENNEDY BOULEVARD, PHILADELPHIA, PA, 19103, US

(73) Assignee: CMOS Sensor Inc., Taipei (TW)

(21) Appl. No.: 10/277,350

(22) Filed: Oct. 22, 2002

(30) Foreign Application Priority Data
Oct. 22, 2001 (TW) 090218016

(51) Int. Cl. H04N 1/031

(52) U.S. Cl. 358/482; 358/484; 358/494

(57) ABSTRACT

A contact image sensor (CIS) for scanning a document is disclosed. The CIS includes a housing having an opening, a first slide and a second slide, a light guide installed on the housing through the opening and the first slide for scanning the document and generating a reflective image, a rod lens installed on the housing through the opening and the second slide for receiving the reflective image and generating a focused image, a PCB installed on the housing and having a sensing array for transforming the focused image into an image signal, and a spring cover fixed on the opening for fixing the light guide and the rod lens in the housing to form the CIS.

### FIELD OF THE INVENTION

This invention relates to a contact image sensor (CIS), and more particularly to an assembly structure of a contact image sensor (CIS).

### BACKGROUND OF THE INVENTION

There are two types of the scanning device in the scanner. One is charge-coupled device (CCD), and the other is contact image sensor (CIS). For the present CIS assembly technology, excluding the former manufacturing processes (i.e. PCB processes including the die bond, wire bond and test), it is accomplished by semi-automatic machines assisted with the manpower in the later manufacturing processes. In addition, for the sheetfed-type CIS, a glass cover is added to protect the CIS itself since the documents always move on the sheetfed-type CIS. As for the flatbed-type CIS, a glass cover is not needed since the documents are stationary on the big glass plate of the flatbed-type CIS.

Please refer to FIGS. 1 and 2 showing the disassembling and assembling structures of a CIS for scanning documents of A4 size according to the prior art. The CIS 20 includes a glass cover 10, a light guide 11 covered by a white plastic plate, a rod lens 12 and a housing 13. To fix the glass cover 10, the light guide 11 and the rod lens 12 on the housing 13, the industrial glue 14 is dispensed on the housing 13 by semi-automatic machines assisted with the manpower in the assembly process. In addition, the printed circuit board (PCB) (not shown) is fixed to the housing 13 by pressed aluminum or hot pressure.

However, the assembly process of CIS using the glue 14 (such as UV glue or silicon glue) to fix the glass cover 10, the light guide 11 and the rod lens 12 on the housing 13 has disadvantages as follows:

1. Time-consuming: If using the silicon glue, those elements are adhered only when the glue is dried. Including the time for preparing the materials, the assembly process needs almost 4 hours.

2. Increase the cost of materials: The industrial UV or silicon glue is very expensive, which becomes an obstruction of costdown.

3. Hard to rework: When reworking a defective semi-finished product formed in the manufacturing process, the light guide and the rod lens, which have been adhered on the housing, must be come off forcedly from the housing. This often causes damage to the light guide and the rod lens. So the reworking process is complicated and difficult.

Therefore, the present invention provides an assembly structure of the CIS to overcome the disadvantages of the prior art described above.

### SUMMARY OF THE INVENTION

It is an object of the present invention to provide an assembly structure of the CIS which increases the assembly efficiency.

It is another object of the present invention to provide an assembly structure of the CIS which decreases the cost of materials.

It is an additional object of the present invention to provide an assembly structure of the CIS which facilitates to rework.

In accordance with an aspect of the present invention, the CIS for scanning a document includes a housing having an opening, a first slide and a second slide; a light guide installed on the housing through the opening and the first slide for scanning the document and generating a reflective image; a rod lens installed on the housing through the opening and the second slide for receiving the reflective image and generating a focused image; a PCB installed on the housing and having a sensing array for transforming the focused image into an image signal; and a spring cover fixed on the opening for fixing the light guide and the rod lens in the housing to form the CIS.

Preferably, the document is one of a card and a paper of A4 size.

Preferably, the opening is on a side of the housing.

Preferably, the CIS further includes at least a first fixer for fixing the light guide.

Preferably, the first fixer is an elastic pressure plate and is formed integrally with the housing.

Preferably, the CIS further includes at least a second fixer for fixing the rod lens.

Preferably, the second fixer is a wedge-shaped hook and is formed integrally with the housing.

Preferably, the CIS further includes at least a locking device for locking the PCB.

Preferably, the locking device is a screw, and the PCB has a hole for threadedly engaging with the screw.

Preferably, the spring cover comprises a cover plate and two protruding pieces having two holes respectively, and the housing has two hooks for interlocking with the spring cover through the holes.

Preferably, the housing has a first groove for facilitating a reworking of the spring cover.

Preferably, the housing has a second groove for facilitating a reworking of the PCB.

Preferably, the CIS further includes a glass cover installed on the light guide to acquire a sheetfed-type CIS.

In accordance with another aspect of the present invention, the CIS for scanning a document includes a housing having an opening, a first slide and a second slide; a light guide installed on the housing through the opening and the first slide for scanning the document and generating a reflective image; a rod lens installed on the housing through the opening and the second slide for receiving the reflective image and generating a focused image; and a PCB installed on the housing and having a sensing array for transforming the focused image into an image signal.

Preferably, the document is one of a card and a paper of A4 size.

Preferably, the opening is on a side of the housing.

Preferably, the CIS further includes at least a first fixer for fixing the light guide.

Preferably, the first fixer is an elastic pressure plate and is formed integrally with the housing.

Preferably, the CIS further includes at least a second fixer for fixing the rod lens.

Preferably, the second fixer is a wedge-shaped hook and is formed integrally with the housing.

Preferably, the CIS further includes at least a locking device for the PCB.

Preferably, the locking device is a screw, and the PCB has a hole for threadedly engaging with the screw.

Preferably, the CIS further includes a spring cover fixed on the for fixing the light guide and the rod lens in the housing.

Preferably, the spring cover comprises a cover plate and two protruding pieces having two holes respectively, and the housing has two hooks for interlocking with the spring cover through the holes.

Preferably, the housing has a first groove for facilitating a reworking of the spring cover.

Preferably, the housing has a second groove for facilitating a reworking of the PCB.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematical view showing the disassembling structure of the CIS according to the prior art;

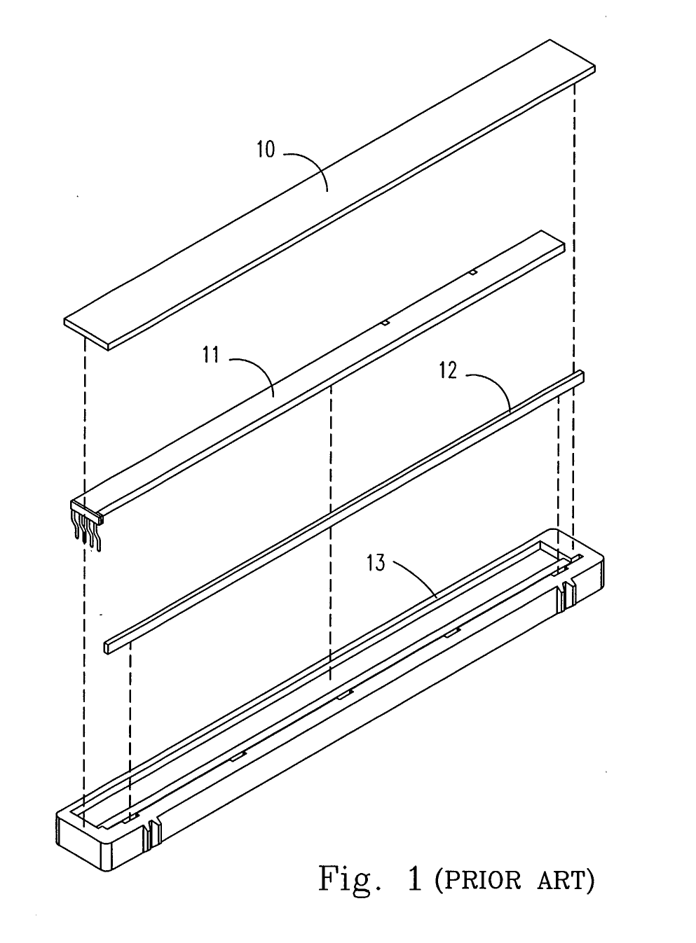

FIG. 2 is a schematical view showing the assembling structure of the CIS in FIG. 1;

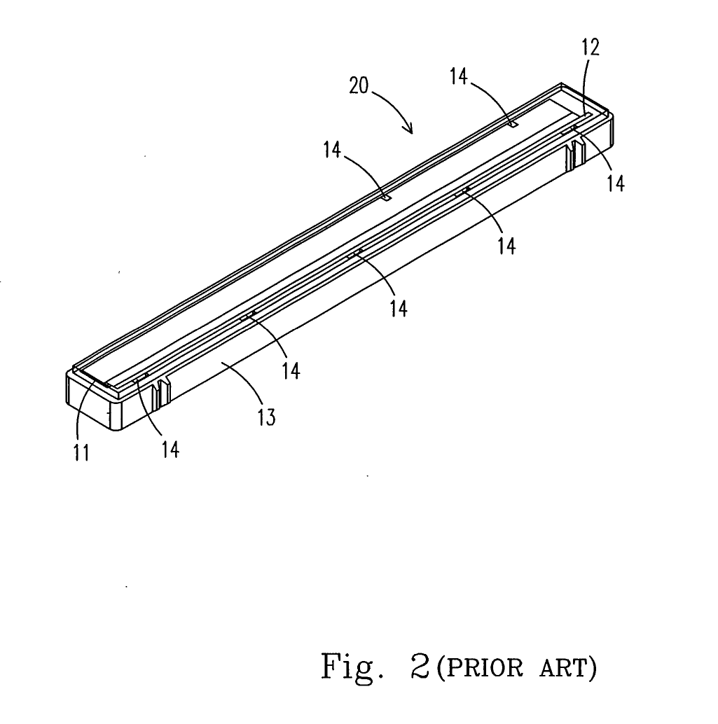

FIG. 3 is a schematical view showing the disassembling structure of the CIS according to a preferred embodiment of the present invention;

FIG. 4 is a schematical view showing the assembling structure of the CIS in FIG. 3;

FIG. 5 is another side view of the housing in FIG. 3; and

FIG. 6 is a bottom view of the CIS in FIG. 4.

### DETAILED DESCRIPTION OF THE PREFERRED EMBODIMENT

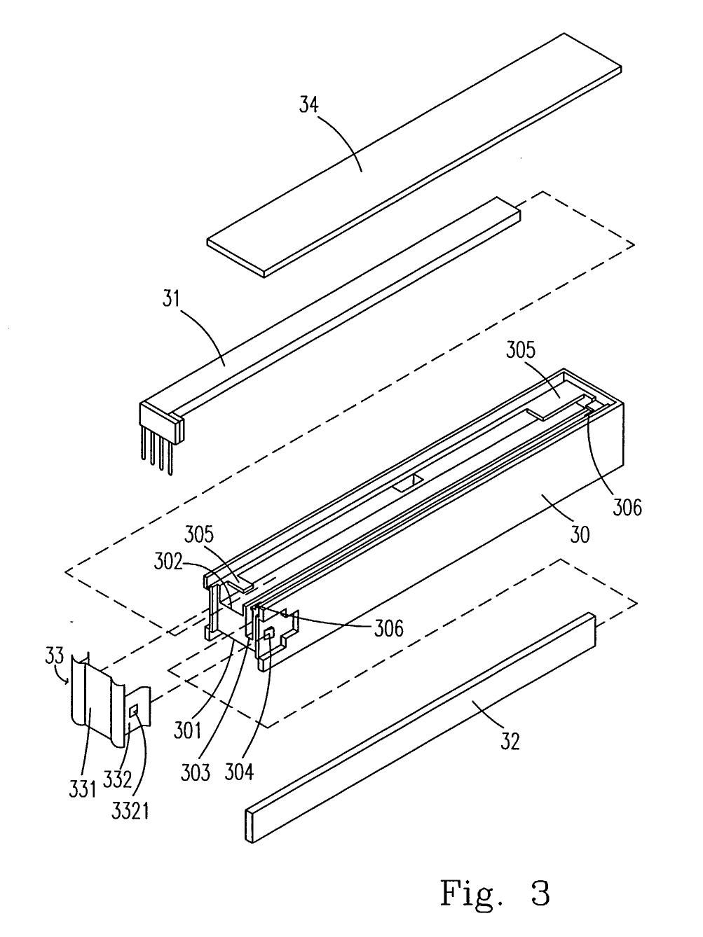

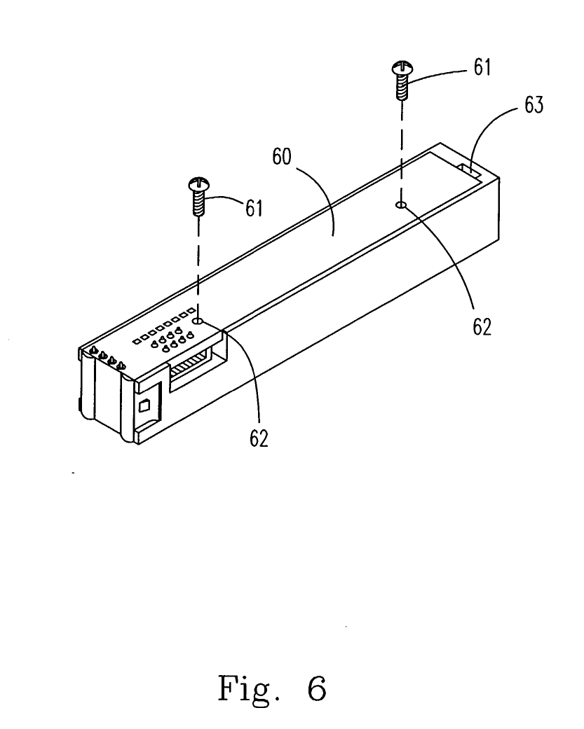

Please refer to FIG. 3 showing the disassembling structure of the CIS according to a preferred embodiment of the present invention. The CIS for scanning a document includes a housing 30, a light guide 31, a rod lens 32 and a PCB 60 (as shown in FIG. 6). The housing 30 has an opening 301 on a side of the housing 30, a first slide 302 and a second slide 303. The light guide 31 is installed on the housing 30 through the opening 301 and the first slide 302, and is used for scanning the document and generating a reflective image. The rod lens is installed on the housing 30 through the opening 301 and the second slide 303, and is used for receiving the reflective image and generating a focused image. The PCB 60 (as shown in FIG. 6) is installed on the housing 30 and having a sensing array for transforming the focused image into an image signal. In addition, the CIS can further includes a cover glass 34 installed on the light guide 31 to acquire a sheetfed-type CIS.

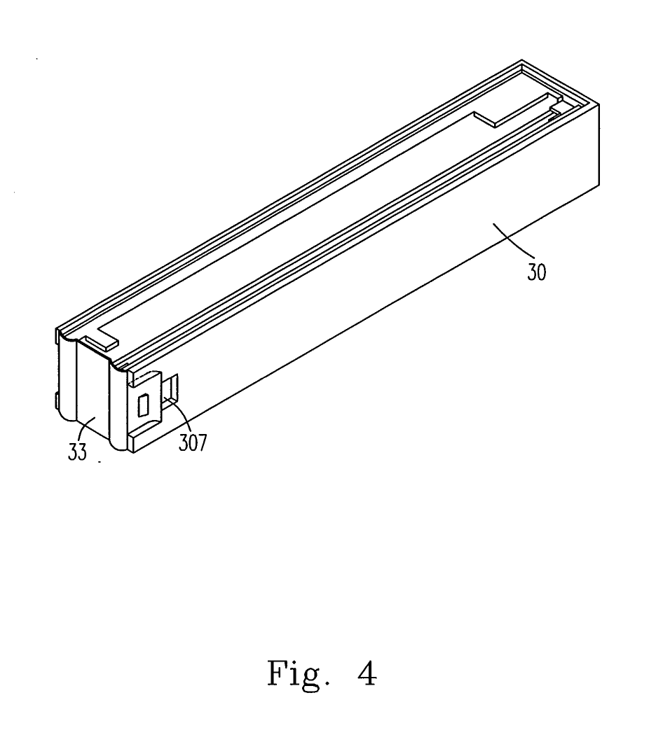

A spring cover 33 is used to fix the light guide 31 and the rod lens 32 in the housing 30 at the side the opening 301 located. The spring cover 33 includes a cover plate 331 and two protruding pieces 332 having two holes 3321 respectively. Accordingly, the housing 30 has two hooks 304 for interlocking with the spring cover 33 through the holes 3321 respectively. Therefore, the spring cover 33 can fix the light guide 31 and the rod lens 32 in the housing 30, and also prevent the light leak (as shown in FIG. 4 showing the assembling structure of the CIS in FIG. 3).

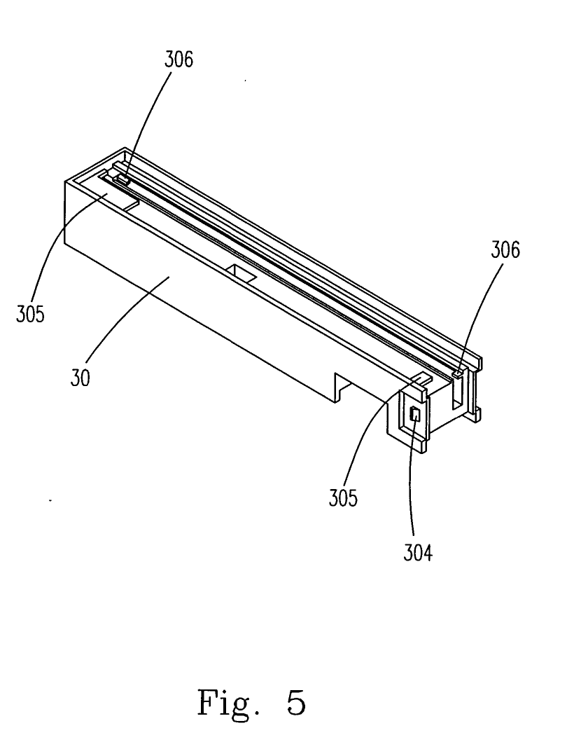

Please also refer to FIG. 5 showing another side view of the housing in FIG. 3. The CIS further includes two first fixers 305 formed integrally with the housing 30. The first fixers 305 are elastic pressure plates used to fix the light guide 31 in the first slide 302 of the housing 30. In the same way, the CIS further includes two second fixers 306 formed integrally with the housing 30. The second fixers 306 are wedge-shaped hooks used to fix the rod lens 32 in the second slide 302 of the housing 30.

Please refer to FIG. 6 showing a bottom view of the CIS in FIG. 4. The CIS further includes two locking devices for locking the PCB 60. The locking devices are screws 31, and the PCB 60 has two holes 62 for threadedly engaging with the screws 61 respectively.

Moreover, the housing of the CIS in the present invention further includes a first groove 307 (as shown in FIG. 4) for facilitating a reworking of the spring cover 33, and a second groove 63 for facilitating a reworking of the PCB 60.

The length of the CIS of the present invention can be 7 cm or 23.6 cm, and therefore the CIS can used for scanning the document being a card or a paper of A4 size.

According to the structure design of the present invention, the CIS can be assembled in two minutes, which is much shorter than that of the prior art.

In conclusion, the present invention provides a new assembly structure of the CIS without using any glue. The light guide and the rod lens can be conducted to their fixed positions in the housing through the first and second slides, and can be fixed by the first and second fixers and the spring cover. Therefore, the present invention can increase the assembly efficiency and decrease the cost of materials. In addition, the present invention has an advantage of facilitating to rework. Thus, the present invention overcomes the disadvantages of the prior art and exhibits the industrial application.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A contact image sensor (CIS) for scanning a document, comprising:
a housing having an opening, a first slide and a second slide;
a light guide installed on said housing through said opening and said first slide for scanning said document and generating a reflective image;
a rod lens installed on said housing through said opening and said second slide for receiving said reflective image and generating a focused image;
a printed circuit board (PCB) installed on said housing and having a sensing array for transforming said focused image into an image signal; and
a spring cover fixed on said opening for fixing said light guide and said rod lens in said housing to form said CIS.

2. The CIS according to claim 1 wherein said document is one of a card and a paper of A4 size.

3. The CIS according to claim 1 wherein said opening is on a side of said housing.

4. The CIS according to claim 1 further comprising at least a first fixer for fixing said light guide.

5. The CIS according to claim 4 wherein said first fixer is an elastic pressure plate and is formed integrally with said housing.

6. The CIS according to claim 1 further comprising at least a second fixer for fixing said rod lens.

7. The CIS according to claim 6 wherein said second fixer is a wedge-shaped hook and is formed integrally with said housing.

8. The CIS according to claim 1 further comprising at least a locking device for locking said PCB.

9. The CIS according to claim 8 wherein said locking device is a screw, and said PCB has a hole for threadedly engaging with said screw.

10. The CIS according to claim 1 wherein said spring cover comprises a cover plate and two protruding pieces having two holes respectively, and said housing has two hooks for interlocking with said spring cover through said holes.

11. The CIS according to claim 1 wherein said housing has a first groove for facilitating a reworking of said spring cover.

12. The CIS according to claim 1 wherein said housing has a second groove for facilitating a reworking of said PCB.

13. The CIS according to claim 1 further comprising a glass cover installed on said light guide to acquire a sheetfed-type CIS.

14. A contact image sensor (CIS) for scanning a document, comprising:
a housing having an opening, a first slide and a second slide;
a light guide installed on said housing through said opening and said first slide for scanning said document and generating a reflective image;
a rod lens installed on said housing through said opening and said second slide for receiving said reflective image and generating a focused image; and
a printed circuit board (PCB) installed on said housing and having a sensing array for transforming said focused image into an image signal.

15. The CIS according to claim 14 wherein said document is one of a card and a paper of A4 size.

16. The CIS according to claim 14 wherein said opening is on a side of said housing.

17. The CIS according to claim 14 further comprising at least a first fixer for fixing said light guide.

18. The CIS according to claim 17 wherein said first fixer is an elastic pressure plate and is formed integrally with said housing.

19. The CIS according to claim 14 further comprising at least a second fixer for fixing said rod lens.

20. The CIS according to claim 19 wherein said second fixer is a wedge-shaped hook and is formed integrally with said housing.

21. The CIS according to claim 14 further comprising at least a locking device for locking said PCB.

22. The CIS according to claim 21 wherein said locking device is a screw, and said PCB has a hole for threadedly engaging with said screw.

23. The CIS according to claim 14 further comprising a spring cover fixed on said opening for fixing said light guide and said rod lens in said housing.

24. The CIS according to claim 23 wherein said spring cover comprises a cover plate and two protruding pieces having two holes respectively, and said housing has two hooks for interlocking with said spring cover through said holes.

25. The CIS according to claim 23 wherein said housing has a first groove for facilitating a reworking of said spring cover.

26. The CIS according to claim 14 wherein said housing has a second groove for facilitating a reworking of said PCB.
